(19) United States
(12) Patent Application Publication
(10) Pub. No.: US 2024/0275571 A1
(43) Pub. Date: Aug. 15, 2024

(54) DEVICES, SYSTEMS, AND METHODS FOR IMPROVING ISOLATION OF TX-RX DUPLEXERS BY DESTRUCTIVE INTERFERENCE

(71) Applicant: Qorvo US, Inc., Greensboro, NC (US)

(72) Inventor: Yazid Yusuf, Orlando, FL (US)

(21) Appl. No.: 18/434,269

(22) Filed: Feb. 6, 2024

Related U.S. Application Data
(60) Provisional application No. 63/484,823, filed on Feb. 14, 2023.

(51) Int. Cl. H04L 5/14; H04B 1/00

(52) U.S. Cl. CPC H04L 5/1461; H04B 1/0057

(57) ABSTRACT

A duplexer system includes a first signal path from a transmit port to a receive port and a second signal path from the transmit port to the receive port. The first signal path includes a first transmit filter, an antenna, and a first receive filter. The second signal path includes a second receive filter, a load, and a second transmit filter. The first signal path and the second signal path are configured such that a first signal received at the receive port from the first signal path is inverted relative to a second signal received at the receive port from the second signal path and the first signal and the second signal destructively interfere at the receive port.

### RELATED APPLICATIONS

This application claims priority to U.S. Provisional Patent Application No. 63/484,823 filed Feb. 14, 2023, which is incorporated by reference herein in its entirety.

### TECHNICAL FIELD

The present disclosure relates generally to transmit-receive duplexers. In particular, a transmit-receive duplexer includes a main signal path and an auxiliary signal path identical to the main signal path apart from a 180-degree relative phase shift isolating a transmit port from a receive port through destructive interference.

### BACKGROUND

A duplexer is a device that allows a single transmission line (such as a coaxial cable or waveguide) to be used by two or more devices simultaneously, while preventing the signals from interfering with each other. A duplexer can be used to separate the transmit (TX) and receive (RX) signals in a system that uses a single antenna for both transmitting and receiving, such as a two-way radio or a mobile phone.

A TX-RX duplexer is a specific type of duplexer that is designed to separate the transmit and receive signals in a communication system. It typically consists of two filters, a transmit and a receive filter, which share a common node, namely, the antenna. The individual filters typically consist of a series of resonant cavities or an arrangement of electrically connected resonators that are designed to pass a specific frequency range, and to reject all other frequencies. The transmit and receive signals are each assigned a specific frequency range, and corresponding transmit and receive filters are designed to pass these frequency ranges. The duplexer is designed to pass the transmit signal from the transmit port to the antenna through the transmit filter and similarly pass the receive signal from the antenna to the receive port through the receive filter. Therefore, the TX-RX duplexer is used to allow the antenna to transmit and receive signals at the same time, without interference. It is an important component of the system, as it allows the device to communicate with other devices while minimizing interference and maximizing the signal-to-noise ratio. In order to minimize the electrical loading of the transmit filter onto the receive filter, and vice versa, the filters are designed to present a high impedance in their alternate frequency bands, which helps minimize the insertion loss of the transmit and receive paths. For this purpose, additional matching components at are typically utilized on the antenna side of either or both filters. The transmit and receive filters are said to be multiplexed at the antenna node.

Isolation via transmit and receive filters of the transmit and receive ports is not without limitation and plays a role in determining the sensitivity of the receiver. Specifically, part of the high-power signal passing through the TX filter leaks through the RX filter and appears at the receiver output due to the finite rejection that the RX filter provides in the TX filter passband frequencies. One approach to improve TX-RX isolation is to increase the RX filter rejection by increasing its order. However, this comes at the expense of increased insertion loss which makes this approach prohibitive especially if high isolation levels are needed.

### SUMMARY

Embodiments of the present disclosure include devices, systems, and methods for improved isolation of transmit-receive duplexers through destructive interference. Aspects of the disclosure advantageously provide near perfect isolation of the receive port of a duplexer from the transmit port of the duplexer. Multiple circuits describing various embodiments are provided that use varying types of filters.

In an exemplary aspect, a duplexer system is provided. The duplexer system comprises a first signal path from a transmit port to a receive port, the first signal path comprising: a first transmit filter; an antenna; and a first receive filter; and a second signal path from the transmit port to the receive port, the second signal path comprising: a second receive filter; a load; and a second transmit filter, wherein the first signal path and the second signal path are configured such that a first signal received at the receive port from the first signal path is inverted relative to a second signal received at the receive port from the second signal path.

In some aspects, an impedance of the load of the second signal path matches an impedance of the antenna of the first signal path. In some aspects, the first transmit filter and the second transmit filter are electrically symmetrical. In some aspects, the first receive filter and the second transmit filter are electrically symmetrical. In some aspects, either the first receive filter and the second receive filter or the first transmit filter and the second transmit filter form a set of coupled resonator filters. In some aspects, one coupled resonator filter the set of coupled resonator filters includes a reverse polarization piezoelectric resonator. In some aspects, one coupled resonator filter of the set of coupled resonator filters is arranged with connection leads that are reversed relative to the other coupled resonator filter of the set of coupled resonator filters. In some aspects, the second signal path further includes a capacitance to ground component corresponding to a difference in capacitance between the coupled resonator filters of the set of coupled resonator filters. In some aspects, each of the first transmit filter, the first receive filter, the second receive filter, and the second transmit filter are coupled resonator filters. In some aspects, either the first receive filter and the second receive filter or the first transmit filter and second transmit filter form a set of stacked crystal filters. In some aspects, one of the stacked crystal filters of the set of stacked crystal filters includes a reverse polarization piezoelectric resonator. In some aspects, either the first receive filter and the second receive filter or the first transmit filter and second transmit filter form a set of hybrid filters, each hybrid filter of the set of hybrid filters including a coupled resonator filter and one or more ladder filter sections. In some aspects, either the first transmit filter and the second transmit filter or the first receive filter and the second receive filter form a set of lattice filters. In some embodiments, each of the first transmit filter, the second transmit filter, the first receive filter, and the second receive filter forms a lattice filters. In some aspects, one lattice filter of the set of lattice filters includes a pair of reversed piezoelectric resonators relative to the other lattice filter of the set of lattice filters. In some aspects, either the first transmit filter and second transmit filter or the first receive filter and second receive filter form a set of hybrid lattice filters, and wherein one hybrid lattice filter of the set of hybrid lattice filters includes a pair of reversed piezoelectric resonators relative to the other hybrid lattice filter of the set of hybrid lattice filters. In some embodiments, each of the first transmit filter, the second transmit filter, the first receive filter, and the second receive filter forms a hybrid lattice filter. In some aspects, the first signal path further comprises a first pair of mutually coupled inductors and the second signal path further comprises a second pair of mutually coupled inductors of opposite polarization than the first pair of mutually coupled inductors. In some embodiments, electrostatic shields are positioned between coupled inductor windings. In some aspects, the second signal path further comprises a pair of mutually coupled inductors with negative mutual coupling and wherein the first signal path includes a plurality of inductors arranged in a T network. In some embodiments, electrostatic shields are positioned between coupled inductor windings. In some aspects, the second receive filter is in electrical communication with the transmit port and an input of the first transmit filter and an input of the second transmit filter is in electrical communication with the receive port and an output of the first receive filter.

In an exemplary aspect, a duplexer system is provided. The duplexer system comprises a first signal path from a transmit port to a receive port, the first signal path comprising an antenna configured to transmit a first signal from the transmit port; and a second signal path from the transmit port to the receive port, the second signal path comprising a component configured to generate a second signal by inverting the first signal such that the first signal and the second signal destructively interfere.

In some aspects, the first signal path includes a first coupled resonator filter and the component of the second signal path is a second coupled resonator filter symmetrical to the first coupled resonator filter, the second resonator filter comprising a piezoelectric resonator of inverted polarity. In some aspects, the second signal path further includes a load and wherein an impedance of the load matches an impedance of the antenna.

In an exemplary aspect, a method is provided. The method comprises transmitting a signal from the transmit port along a first signal path and a second path, the first signal path comprising: a first transmit filter; an antenna; and a first receive filter; the second signal path comprising: a second receive filter; a load; and a second transmit filter, and receiving the signal at the receive port wherein an amplitude of the signal received is decreased by destructive interference.

Additional aspects, features, and advantages of the present disclosure will become apparent from the following detailed description.

### BRIEF DESCRIPTION OF THE DRAWINGS

Illustrative embodiments of the present disclosure will be described with reference to the accompanying drawings, of which:

FIG. 1 is a schematic diagram of a dual inverted duplexer, according to aspects of the present disclosure.

FIG. 2A is a schematic diagram of a coupled resonator filter, according to aspects of the present disclosure.

FIG. 2B is a schematic diagram of a coupled resonator filter with an inverted piezoelectric layer, according to aspects of the present disclosure.

FIG. 3A is a schematic diagram of a dual inverted duplexer including coupled resonator filters, according to aspects of the present disclosure.

FIG. 3B is a schematic diagram of a dual inverted duplexer including coupled resonator filters, according to aspects of the present disclosure.

FIG. 4 is a graphical representation of transmit port and receive port isolation using a dual inverted duplexer, according to aspects of the present disclosure.

FIG. 5A is a schematic diagram of a dual inverted duplexer including coupled resonator receive filters, according to aspects of the present disclosure.

FIG. 5B is a schematic diagram of a dual inverted duplexer including coupled resonator receive filters, according to aspects of the present disclosure.

FIG. 6 is a schematic diagram of a dual inverted duplexer including coupled resonator receive filters with ladder sections, according to aspects of the present disclosure.

FIG. 7 is a schematic diagram of a dual inverted duplexer including lattice filters, according to aspects of the present disclosure.

FIG. 8 is a schematic diagram of a dual inverted duplexer including hybrid lattice filters, according to aspects of the present disclosure.

FIG. 9 is a graphical representation of transmit port and receive port isolation using a dual inverted duplexer including hybrid lattice filters, according to aspects of the present disclosure.

FIG. 10A is a schematic diagram of a ladder-based dual inverted duplexer, according to aspects of the present disclosure.

FIG. 10B is a schematic diagram of a ladder-based dual inverted duplexer, according to aspects of the present disclosure.

FIG. 10C is a schematic diagram of a ladder-based dual inverted duplexer, according to aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

In some aspects, an antenna used for simultaneously transmitting and receiving wireless signals is electrically coupled to a transmit port and a receive port. A transmit filter is positioned between the transmit port and the antenna and configured to pass signals within a range of frequencies and filter all other signals. A receive filter is positioned between the receive port and the antenna and configured to pass signals within a range of frequencies different from the range of frequencies of the transmit filter. When a signal is passed from the transmit port to the antenna, as long as the signal is within the transmit filter passband, the signal is passed to the antenna and, in part, prevented from reaching the receive port by the receive filter. When a signal is received, as long as the signal is within the receive filter passband, it is allowed to pass to the receive port, while the transmit filter in part prevents the signal from reaching the transmit port.

To more fully isolate the receive port from the transmit port, an additional signal path is created from the transmit port to the receive port. While the circuity described above may be referred to as a main signal path, the additional signal path may be referred to as an auxiliary path. The auxiliary path includes a transmit filter effectively identical to the transmit filter of the main signal path and a receive filter effectively identical to the receive filter of the main signal path. The auxiliary path also includes a load to ground configured to be electrically identical to the antenna of the main signal path. One of the components of the auxiliary signal path is then configured to invert the signal along the path. In that regard, when a signal is incident into the TX port, the majority of the signal goes through the main path while a much smaller portion goes into the auxiliary path. Most of the signal in the main path emerges at the ANT as desired signal, but a small portion leaks through the RX filter. Besides this signal received by the receive port through the main path, the receive port also receives a second signal through the auxiliary path. Through design considerations subsequently described, the two signals received are made to be effectively identical but the signal from the auxiliary signal path is inverted relative to the signal of the main signal path. As a result, the two signals destructively interfere, such that the signal from the transmit port observed at the receive port is minimized.

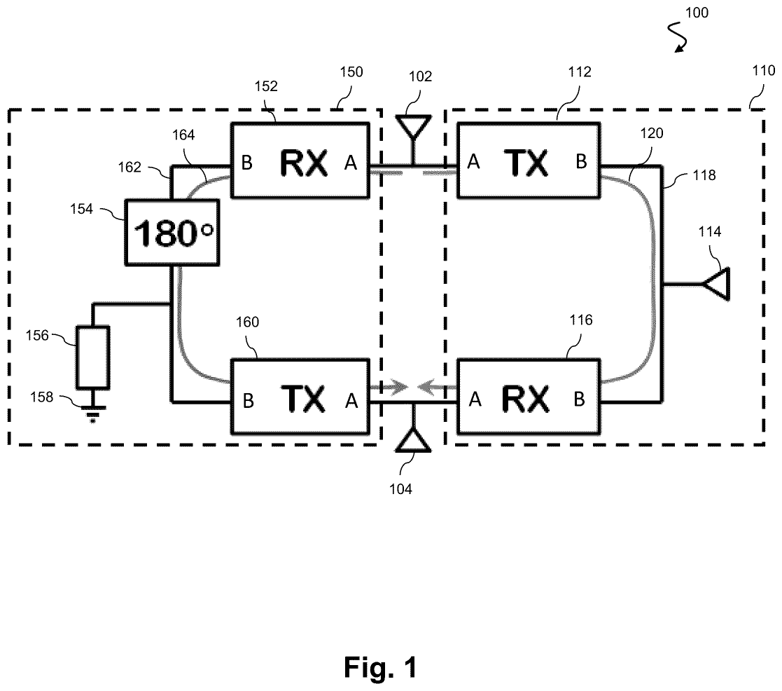

FIG. 1 is a schematic diagram of a dual inverted duplexer 100, according to aspects of the present disclosure. As shown, the dual inverted duplexer 100 includes two signal paths, a main signal path 110 and an auxiliary signal path 150. The main signal path 110 is a single duplexer circuit wherein a transmit port 102 and a receive port 104 are both in electrical communication with an antenna 114. A transmit filter 112 is positioned between the transmit port 102 and an antenna 114 and a receive filter 116 is positioned between the receive port 104 and the antenna 114.

In some aspects, a duplexer circuit may include only the main signal path 110. In such a scenario, the transmit filter 112 is a component of the main signal path 110 that is designed to pass the transmit (TX) signal (e.g., a signal sent from the transmit node 102 to the antenna 114) at a transmit frequencies, while rejecting all signals of other frequencies. The transmit filter 112 is used to pass signals in the TX band to the antenna as efficiently as possible and reject other frequencies preventing them from leaking to the antenna and receive ports. In some aspects, the transmit filter 112 may be a resonant cavity or a bandpass filter, which is designed to pass signals in a specific frequency range and to reject all signals of other frequencies. The transmit filter 112 is placed between the transmitter at transmit node 102 and the antenna 114, as shown in FIG. 1. In this way, the transmit filter 112 helps to minimize interference. The transmit filter 112 is typically designed to have a high Q factor (quality factor) in order to minimize the insertion loss within the passband and improve transceiver efficiency.

Similarly, the receive filter 116 is a component of the main signal path 110 that is designed to pass the receive (RX) signal, while rejecting all other frequencies. It is used to isolate the receive signal from the transmit signal and to reject signals at other unwanted frequencies, and to ensure that the receive signal is received at the receive port 104 as accurately as possible. The receive filter 116 may include a resonant cavity or any other type of bandpass filter, which is designed to pass a specific frequency range and to reject all other frequencies. It is typically placed between the antenna 114 and the receiver at receiver port 104, and its purpose is to pass the receive signal to the receiver port 104 while preventing any other signals or noise from interfering with the receive signal. The receive filter 116 helps to improve the signal-to-noise ratio of the receive signal and to minimize interference from other sources. It is typically designed to have a high Q factor (quality factor) in order to maximize the passband and to minimize the insertion loss.

While a duplexer circuit, such as the main duplexer circuit 110 shown in FIG. 1 is generally effective at isolating transmit and receive signals, it does not achieve perfect isolation. Without the auxiliary signal path 150 described hereafter, the signal path 110 introduces some level of crosstalk between the transmit and receive ports, or undesired coupling of energy from one port to the other. This is caused by the imperfect rejection of the filters.

As shown in FIG. 1, by implementing the auxiliary signal path 150 to form a dual inverted duplexer, the transmit-receive isolation of the duplexer may be significantly improved. In particular, the auxiliary signal path 150 includes a receive filter 152, a transmit filter 160, a load 156 to ground 158 and a mechanism 154 for inverting the signal by 180 degrees. Note that in the configuration in FIG. 1, each transmit filter may be multiplexed on both sides with other receive filters, and similarly, every receive filter may be multiplexed on both sides with other transmit filters. This is in contradistinction with more conventional duplexer circuits where the transmit and receive filters are multiplexed on only one side, namely, the antenna. As described earlier, multiplexing filters generally requires additional matching components to minimize electrical loading and improve insertion loss. In FIG. 1, such additional matching components may be implicitly assumed as part of the filters.

As shown in FIG. 1, the dual inverted duplexer 100 achieve greater isolation of the transmit and receive ports and their corresponding signals by cancellation. In this approach, when power is incident into the transmit port 102, signals pass through both the signal path 110 and the auxiliary signal path 150. The auxiliary signal path 150 is an alternate path for the transmit signal 164 that has the same strength (amplitude or magnitude) as the transmit signal 120 sent down the main signal path 110, but is out of phase by 180 degrees caused by the signal inverting mechanism 154. This means that the two signals have opposite polarity and are out of phase with each other. When these two signals are combined at the receive port 104, they destructively interfere, or provide cancelation of each other. In an ideal situation, the two signals would completely cancel each other out, resulting in no residual signal at the receive port 104. This would allow the receive port 104 to receive only the desired receive signal, without interference from the transmit signal. It is important to note that even though the transmit signal is substantially cancelled at the receive port 104, it is still being transmitted through the antenna 114 at a high power level. The dual inverted duplexer 100 simply creates an alternate path (e.g., the auxiliary signal path 150) for the transmit signal that is out of phase with the transmit signal of the main signal path 110, allowing the two signals to cancel at the receive port 104.

As mentioned previously, each transmit (receive) filter in FIG. 1 may be designed to be multiplexed with other receive (transmit) filters on both of its sides. Generally, it is possible to design the transmit and the receive filters to be multiplexed differently on their two sides provided they interface properly with the opposing filter. In other words, the filters can be designed to be asymmetric with electrical characteristics being different as seen from their two different sides. The different sides of the filters are labelled with letters A and B in FIG. 1. Note that side A of every transmit filter is multiplexed with side A of every receive filter. Similarly, side B of every transmit filter is multiplexed with side B of every receive filter. In addition, the same impedance is used for all ports and/or loads connecting to any specific side of transmit/receive filter. More specifically, in FIG. 1, the impedance of ports 102 and 104 are made identical whereas the impedance of port 114 and load 156 are identical. Under these restrictions, as shown in FIG. 1, the auxiliary signal path 150 is essentially the same duplexer circuit as the main signal path 110 but the load 156 replaces the antenna 114. The load 156 may be a resistor, such as a 50 Ohm resistor or other impedance device, which may be coupled to ground. As a result, in the ideal situation the only difference between the auxiliary signal path 150 and the main signal path 110 is the 180 degree phase shift introduced by the mechanism 154 in the auxiliary signal path 150. In some aspects, the design of the dual inverted duplexer in FIG. 1 can be simplified by utilizing electrically symmetric filters, whereby the input impedances seen looking into the two sides of each filter are identical. In other words, side A of every filter is made electrically identical to side B of that given filter. With this design choice, the impedances of ports 102, 104 and 114, and the load 156 are ideally identical for optimum balance and cancellation of the main and auxiliary signal paths.

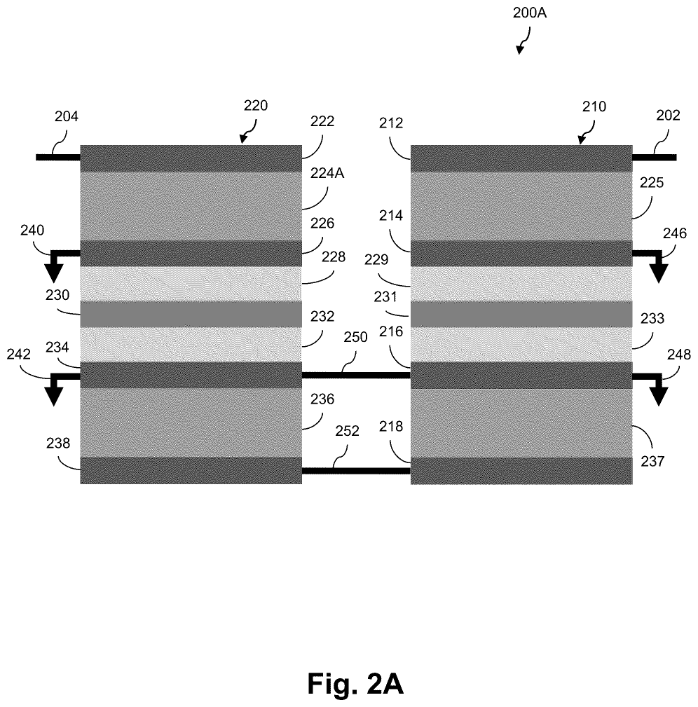

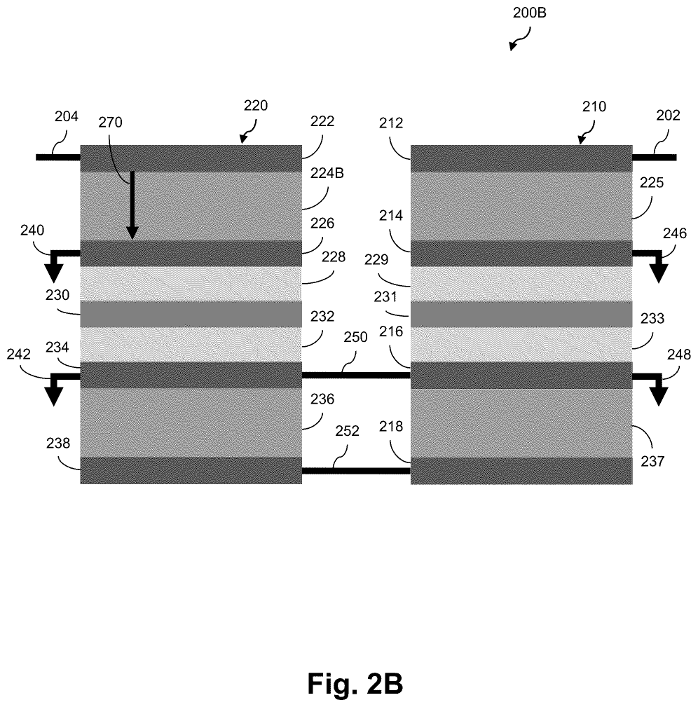

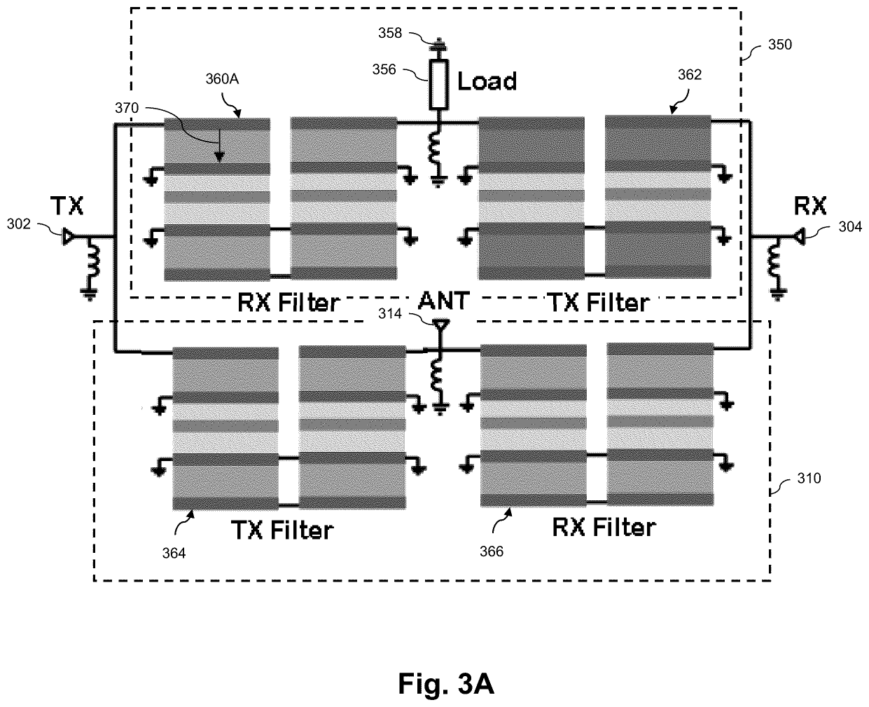

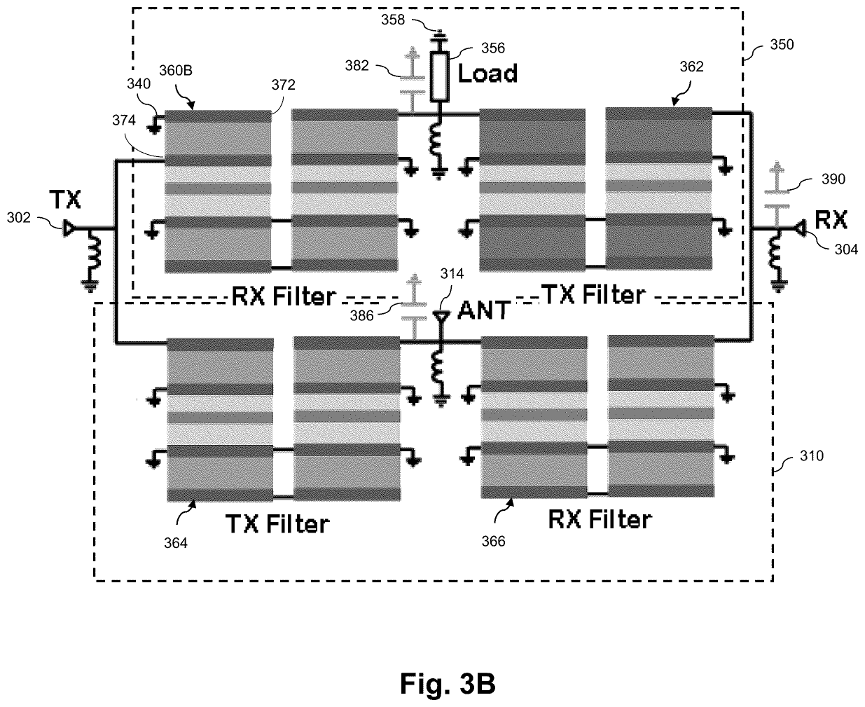

FIG. 2A is a schematic diagram of a coupled resonator filter 200A that may be utilized in some aspects of the present disclosure. Referring to FIGS. 3A, 3B, 5A, 5B, and 6 hereafter, any of the coupled resonator filters of these figures may share any suitable aspects with the coupled resonator filter 200A shown and described with reference to FIG. 2A. As shown in FIG. 2A, the coupled resonator filter 200 may include a first set of layers 210 and a second set of layers 220. Although the layers of the second set of layers 220 are described in more detail herein, the first set of layers 210 may be similar or identical to the second set of layers 220. In particular, the first set of layers 210 may include an electrode 212, a piezoelectric layer 225, an electrode 214, a dielectric layer 229, a conductive layer 231, a dielectric layer 233, an electrode 216, a piezoelectric layer 237, and an electrode 218. Similarly, the second set of layers 220 includes an electrode 222, a piezoelectric layer 224A, an electrode 226, a dielectric layer 228, a conductive 230, a dielectric layer 232, an electrode 234, a piezoelectric layer 236, and an electrode 238. As additionally shown in FIG. 2A, the coupled resonator filter 200A may be implemented along any particular conductor via the electrode 222 of the second set of layers 220 and the corresponding electrode 212 of the first set of layers 210. For example, a conductor 202 may be in communication with the electrode 212 and a conductor 204 may be in communication with the electrode 222. A conductor 250 may bring the electrode 216 and the electrode 234 into electrical communication. Similarly, a conductor 252 may bring the electrode 218 and the electrode 218 into electrical communication.

The electrodes shown in FIG. 2A may be terminal points that are used to connect the various components of the coupled resonator filter 200A to the rest of the circuit. The electrodes may be made from a conductive material, such as copper or silver, and may be used to apply a voltage to the filter.

In some aspects, the dielectric layer 228, conductive layer 230, and dielectric layer 232 may form an acoustic coupling layer. It is noted that any suitable type of acoustic coupling may be used in addition to or alternatively from the dielectric layer 228, conductive layer 230, and dielectric layer 232 shown in FIG. 2A. In some aspects, the coupling layer may include a low acoustic impedance layer and/or a high acoustic impedance layer.

As shown by the conductors 240, 242, 246, and 248 in FIG. 2A, each of the electrodes 226, 234, 214, and 216 may be grounded. The electrodes 226, 234, 214, and 216 (e.g., the electrodes of the acoustic coupling layer) may be grounded.

In some aspects, the coupled resonator filter 200A is a type of electronic filter that is used to pass or reject a specific frequency range in a communication system. It includes a series of coupled resonators (e.g., the piezoelectric layers 224A, 236, etc.). These coupled resonators may be acousto-electric components that are designed to resonate at a specific frequency. The resonators may be connected in a specific configuration, such as in parallel or in series, in order to produce the desired frequency response. Coupling between the resonators may be achieved acoustically through coupling layers (between 224 and 236 and between 225 and 237) or electrically such as in between 236 and 237 whereby additional electrical components (inductor or capacitors) may be used. The coupling coefficients (the degree of coupling between the resonators) can be adjusted in order to shape the frequency response of the filter 200A.

In particular, coupled resonator filter 200A can receive a signal on conductor 204. The signal drives the piezoelectric layer 224A. The acoustic coupler formed by layers 228, 230, and 232 couple the signal to piezoelectric layer 236 and the electrical signal generated is coupled through conductors 252 and 250 to piezoelectric layer 237. The acoustic coupler formed by layers 229, 231, and 231 couples the signal to piezoelectric layer 225 to generate an electrical signal to conductor 202. As will be recognized by those of skill in the art, a similar signal path may be followed by a signal received via the conductor 202. As was discussed above, the layers of the filter 200A are arranged such that the filter 200A operates at a particular frequency (e.g., the transmit signal carrier frequency or the receive signal carrier frequency).

FIG. 2B is a schematic diagram of a coupled resonator filter 200B with an inverted piezoelectric layer 224B, according to aspects of the present disclosure. As shown, the coupled resonator filter 200B may be substantially similar to the coupled resonator filter 200A. For example, the coupled resonator filter 200B may include the same layers as described with reference to the coupled resonator filter 200A. However, as shown by the arrow 270, the piezoelectric layer 224B may be reversed relative to the piezoelectric layer 224A, such that a signal received via the conductor 202 and transmitted from the coupled resonator filter 200B via the conductor 204 (or vice versa) is inverted by the coupled resonator filter 200B.

FIG. 3A is a schematic diagram of a dual inverted duplexer including coupled resonator filters, according to aspects of the present disclosure. The dual inverted duplexer shown in FIG. 3A may be similar to the dual inverted duplexer shown and described with reference to FIG. 1, but may specifically implement coupled resonator filters as shown in FIG. 2A. For example, the dual inverted duplexer shown in FIG. 3A may include a transmit port 302, a receive port 304, an antenna 314, and a load 356 to ground 358. A coupled resonator 364 may be positioned between the transmit port 302 and the antenna 314 and a coupled resonator 366 may be positioned between the antenna 314 and the receive port 304. In some aspects, the coupled resonator 364, the antenna 314, the coupled resonator filter 366 may form a main signal path 310 from the transmit port 302 to the receive port 304. A coupled resonator filter 360A is positioned between the transmit port 302 and the load 356. A coupled resonator filter 362 may be positioned between the load 356 and the receive port 304. In some aspects, the coupled resonator filter 360A, the load 356, and the coupled resonator filter 362 may form an auxiliary signal path 350. In that regard, the auxiliary signal path 350 including the load 356 and the main signal path 310 including the antenna 314 exhibit the same electrical response apart from a 180-degree phase inversion.

As shown in FIG. 3A, the coupled resonator filter 360A may invert the signal of the auxiliary signal path 350. For example, as shown by the arrow 370, the piezoelectric layer of the arrow 370 may be inverted, or of reverse polarization, such that the signal from the transmit port 302 is inverted. It is noted that any piezoelectric layer of either of coupled resonator filter 360A or coupled resonator filter 362 may be inverted to achieve the signal inversion needed for the auxiliary signal path 350. Referring to FIG. 2A, the filters 362, 364, and 366 may be structurally similar to the coupled resonator filter 200A. Referring to FIG. 2B, the filter 360A may be similar to the coupled resonator filter 200B. It is also noted that the filters 364 and 366 are structurally different so that they have different resonant frequencies appropriate for transmission and receiving, respectively. Similarly, the filters 360A and 362 are structurally different so that they have different resonant frequencies to match the filters 366 and 364 respectively.

FIG. 3B is a schematic diagram of a dual inverted duplexer including coupled resonator filters, according to aspects of the present disclosure. As shown, aspects of the dual inverted duplexer shown in FIG. 3B may be similar to those shown and described with reference to FIG. 3A. However, the method of inverting the signal of the auxiliary signal path 350 may differ. In some aspects, the coupled resonator filters described herein may alternatively be stacked crystal filters.

In some aspect, the coupled resonator filter 360B may achieve signal inversion because the conductor from the transmit port 302 to the coupled resonator filter 360B is coupled to the electrode 374 of the filter 360B as opposed to the electrode 372. As shown, the electrode 372 may be connected to ground via the conductor 340.

While reversing the connections of the electrodes of the coupled resonator filter as shown in FIG. 3B provides the 180-degree phase shift needed for destructive interference, it also creates an additional capacitance to ground. Because as close as possible to perfect amplitude balance at all junctions of the circuit are needed for ideal destructive interference, this additional capacitance to ground must be compensated for. When an additional capacitance to ground is present, it can affect the balance of amplitudes at various points in the circuit. Therefore, to compensate for the additional capacitance to ground created by reversing the connections of the electrodes, an additional capacitance to ground can be added at every junction to match the capacitances throughout the circuit. In that regard, a capacitor 382 may be positioned from the conductor between the coupled resonator filter 360B and the load 356 to ground. Similarly, a capacitor 386 may be positioned between the conductor from the coupled resonator filter 364 to the antenna 314 to ground. A capacitor 390 may similarly be positioned from the conductor leading to the receive port 304 to ground. This arrangement helps to restore the balance of amplitudes and allows the circuit to function symmetrically.

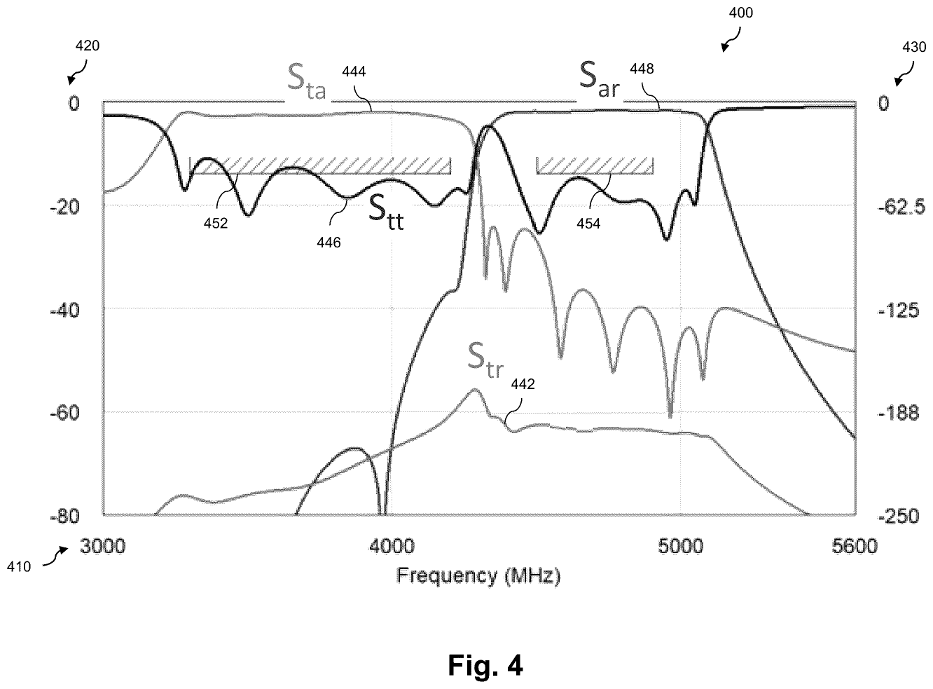

FIG. 4 is a graphical representation of transmit port and receive port isolation using a dual inverted duplexer, according to aspects of the present disclosure. As shown, FIG. 4 includes a plot 400. In particular, the data shown in the plot 400 may illustrate the performance of the dual inverted duplexer described with reference to FIG. 3A and/or FIG. 3B. In that regard, the plot 400 includes an axis 410 corresponding to frequency, an axis 420 corresponding to attenuation and reflection loss, and an axis 430 corresponding to isolation, all expressing amplitudes in dB.

As shown in FIG. 4, the plot includes various data including a data set 444, a data set 448, a data set 446, and a data set 442. Each of these data sets correspond to scattering parameters (S-parameters) of different ports of either of the dual inverted duplexers of FIGS. 3A and 3B. These different ports may include, for example, the transmit port 302, the receive port 304, and the antenna 314. In that regard, the data sets 442-448 may correspond to the ratio of voltage wave amplitudes observed at one of these ports as power is fed into one of these ports (in some cases the same port or a different port). In some aspects, as shown by the axes 420 and 430, these measurements may be displayed in decibels (dB). In particular, the absolute value of each observed voltage ratio may be squared, converting the measured voltage ratios to power ratios, and converted into dB values with a logarithmic function. In that regard, the ports-parameters in dB may be illustrated in the plot 400 of FIG. 4 with each data point being calculated according to Sij(dB)=10*log(|Sij|²), where Sij corresponds to the ratio of voltage measured at a port i of the circuit to the incident voltage at port j and Sij(dB) represents the corresponding value in dB. In reciprocal circuits described herein

In particular, the data set 444 may represent power transmitted from the transmit port to the antenna (Sₜₐ). In other words, the data set 444 corresponds to power measured at the antenna when power is fed into the transmit port. In that regard, it may be desirable to optimize power from the transmit port to the antenna within the passband of frequencies (i.e., ˜3200 MHz-4200 MHz in the example shown in FIG. 4, though this passband may be selected to be any suitable range as needed) and minimized at all other frequencies. In other words, within the passband, the dB loss from the transmit port to the antenna should be as low as possible, or as close to 0 dB as possible. As shown in FIG. 4, the dB loss of the data set 444 representing power from the transmit port to the antenna is very low (i.e., around 2 dB or less). In the plot 400 shown, the data set 444 corresponds to the left axis 420.

The data set 448 may represent power transmitted from the antenna to the receive port (Sₐᵣ). In other words, the data set 448 corresponds to power measured at the receive port when power is fed into the antenna. Within the passband of frequencies for the receive signal path (i.e., ˜4400 MHz-5100 MHz in the example shown in FIG. 4, though this passband may be selected to be any suitable range as needed), it may be desirable to optimize power from the antenna to the receive port, or that the loss within this passband be as low as possible, or as close to 0 dB as possible. As shown in FIG. 4, the dB loss of the data set 448 representing power from the antenna to the receive port is very low (i.e., around 2 dB or less). In the plot 400 shown, the data set 448 corresponds to the left axis 420.

The data set 446 may correspond to power reflected back to the transmit port (Sₜₜ). In other words, the data set 446 corresponds to reflected power measured at the transmit port when power is fed into the transmit port. In particular, when power is fed through the transmit port into the dual inverted duplexer circuit (e.g., through the transmit port 302), some amount of power is reflected back through the transmit port. This amount of power may be illustrated by the data set 446. In some aspects, it may be desirable for the amount of reflected power to be less than 15 dB within the transmit and/or receive passbands. To illustrate this goal, indicators 452 and 454 are provided. The indicators 452 and 454 show the 15 dB loss along the transmit and receive passbands respectively. As shown, within these passbands, the reflected dB loss is largely at or below 15 dB. In the plot 400 shown, the data set 446 may correspond to the left axis 420. It is noted, that due to the symmetry of the dual inverted duplexer circuits described herein, the data set 446 may equally represent power reflected at any of the ports of the circuit, including at the receive port or the antenna.

The data set 442 may correspond to power leakage from the transmit port to the receive power, or Tx-Rx leakage (Sₜᵣ). In other words, the data set 442 corresponds to power measured at the receive port when power is fed into the transmit port. In the plot 400 shown, the data set 442 corresponds to the right axis 430. As shown in the plot 400, the amount of power which leaks from the transmit port to the receive port is extremely low due to the cancellation effect between the main signal path and auxiliary signal path. In the example shown, the data set 442 shows a dB loss of around 200 dB (i.e., ˜180-250 dB frequency dependent loss) which corresponds to essentially perfect isolation of the receive port from the transmit port.

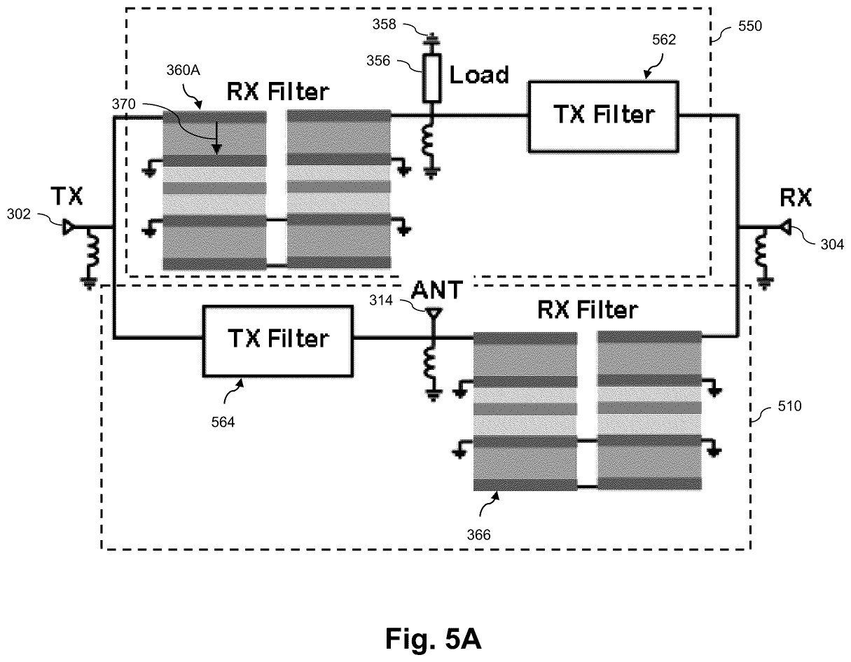

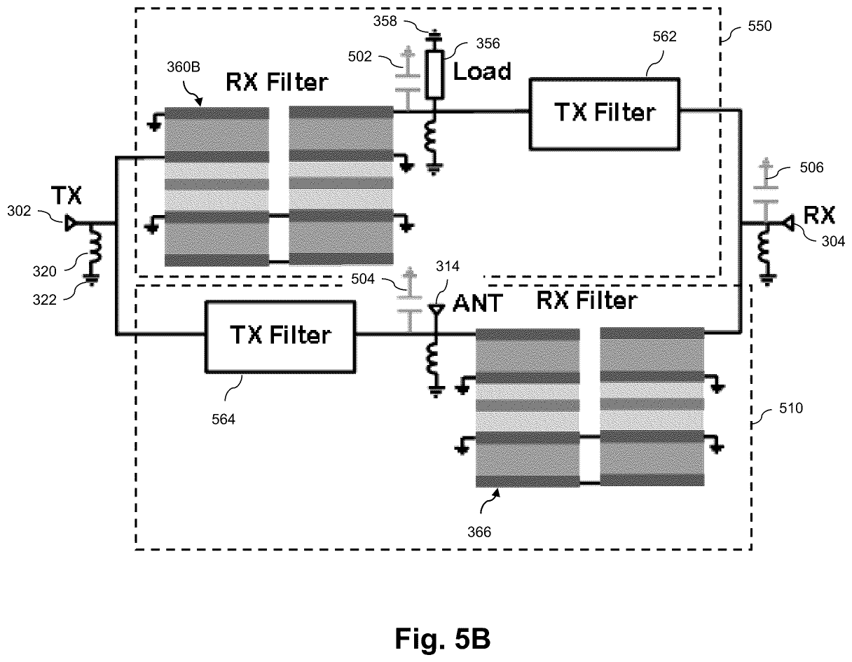

FIG. 5A is a schematic diagram of a dual inverted duplexer including coupled resonator receive filters, according to aspects of the present disclosure. The dual inverted duplexer shown in FIG. 5A may be similar to either of the dual inverted duplexers shown and described with reference to FIGS. 3A and 3B.

In particular, the dual inverted duplexer of FIG. 5A includes the same transmit port 302, receive port 304, antenna 314, and load 356 as well as all of the respective corresponding components. The dual inverted duplexer includes the same coupled resonator filters 360A and 366 as the receive filters. As shown by the arrow 370, the signal of the auxiliary signal path 350 including the coupled resonator filter 360A, load 356, and transmit filter 562 is inverted via an inverted piezoelectric layer of the coupled resonator filter 360A.

However, as shown in FIG. 5A, the transmit filters 562 and 564 may be any suitable type of filter and need not be coupled resonator filters as illustrated in FIGS. 3A and 3B. For example, the transmit filters 562 and 564 may include ladder filters, lattice filters, hybrid lattice filters, Butterworth filters—particularly of higher order, Chebyshev filters, elliptic filters, Bessel filters, Cauer filters, Gaussian filters, or any other suitable type of bandpass filter. As described with reference to FIG. 1 previously, the transmit filters selected for the dual inverted duplexer of FIG. 5A may be selected to be electrically symmetrical. The auxiliary signal path 550 is substantially identical to the main signal path 510 except for the signal inversion created by the inverted piezoelectric of the coupled resonator filter 360A.

FIG. 5B is a schematic diagram of a dual inverted duplexer including coupled resonator receive filters, according to aspects of the present disclosure. The dual inverted duplexer shown in FIG. 5B may be similar to either of the dual inverted duplexers shown and described with reference to FIGS. 3A, 3B, and 5A.

In particular, the dual inverted duplexer of FIG. 5B includes the same transmit port 302, receive port 304, antenna 314, and load 356 as well as all of the respective corresponding components. The dual inverted duplexer includes the same coupled resonator filters 360B and 366 as the receive filters. However, as shown by the lead from the transmit port 302 being connected to the second electrode, the signal of the auxiliary signal path 550 including the coupled resonator filter 360B, load 356, and transmit filter 562 is inverted. In that regard, the description of signal inversion by the coupled resonator filter 360B as described at FIG. 3B equally applies to the example shown in FIG. 5B.

Like the dual inverted duplexer of FIG. 5A, the transmit filters 562 and 564 may be any suitable type of filter and need not be coupled resonator filters necessarily. For example, the transmit filters 562 and 564 may include any of the example filters described with reference to FIG. 5A. As described with reference to FIG. 1 previously, the transmit filters selected for the dual inverted duplexer of FIG. 5B may be selected to be electrically symmetrical Additional capacitance to ground can be provided to help with electrical symmetry, including a capacitor 502 positioned adjacent to the load 356, a capacitor 504 adjacent to the antenna 314, and an additional capacitor adjacent to the receive port 506 may be implemented to compensate for the difference in capacitance to ground caused by switching the lead from the transmit port 302 to the receive filter 360B, as described with reference to FIG. 3B previously. In some aspects, compensating capacitance to ground may be provided via any one of the capacitors 502, 504, or 506 alone. In some aspects, in the implementation shown in FIG. 5B, compensating capacitance to ground may be provided by the capacitor 506 alone.

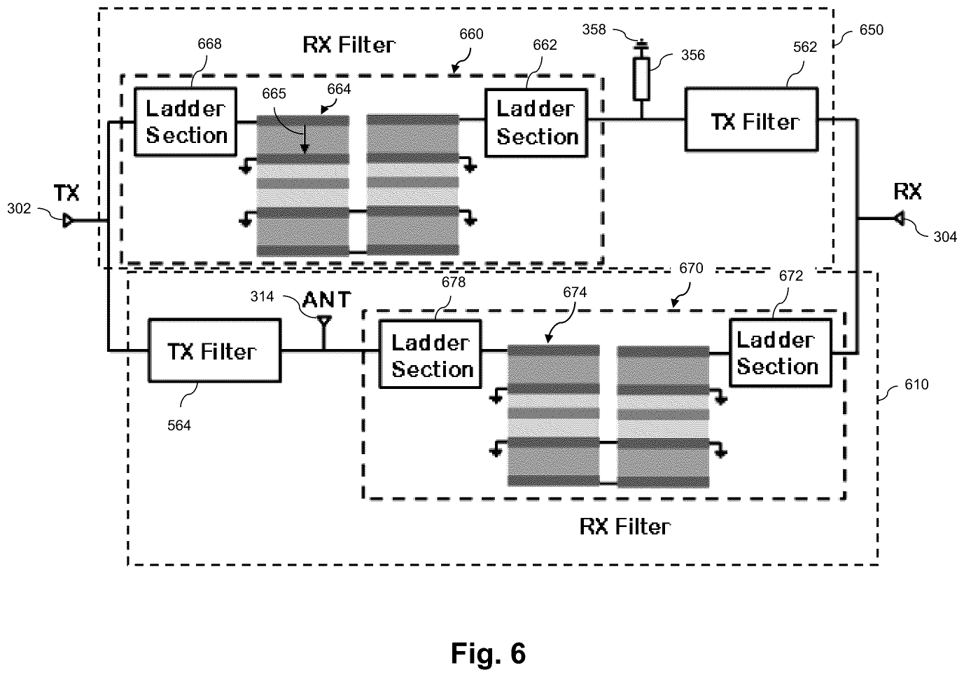

FIG. 6 is a schematic diagram of a dual inverted duplexer including coupled resonator receive filters with additional ladder sections, according to aspects of the present disclosure. FIG. 6 illustrates an example in which multiple types of filters may be combined to form the receive filters of the dual inverted duplexer. However, the same principles may apply to the transmit filters as well. In the example shown in FIG. 6, the receive filters include a receive filter 660 in the auxiliary signal path 650 (e.g., the path from the transmit port 302 to the receive port 304 including the receive filter 660, the load 356 to ground 358, and the transmit filter 562) and a receive filter 670 in the main signal path 610 (e.g., the path from the transmit port 302 to the receive port 304 including the transmit filter 564, the antenna 314, and the receive filter 670).

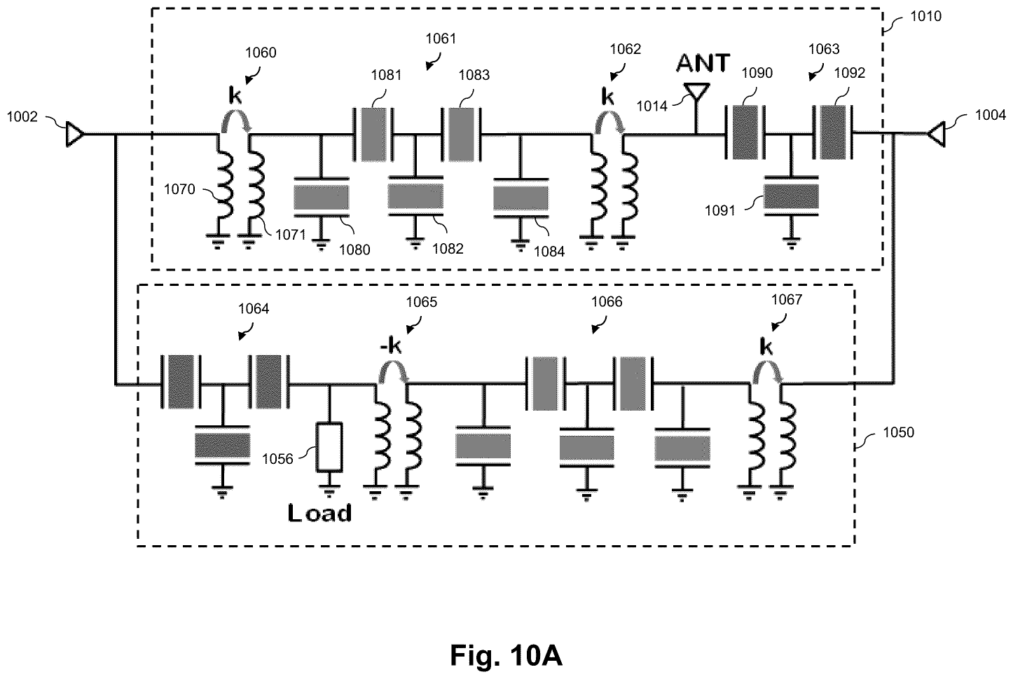

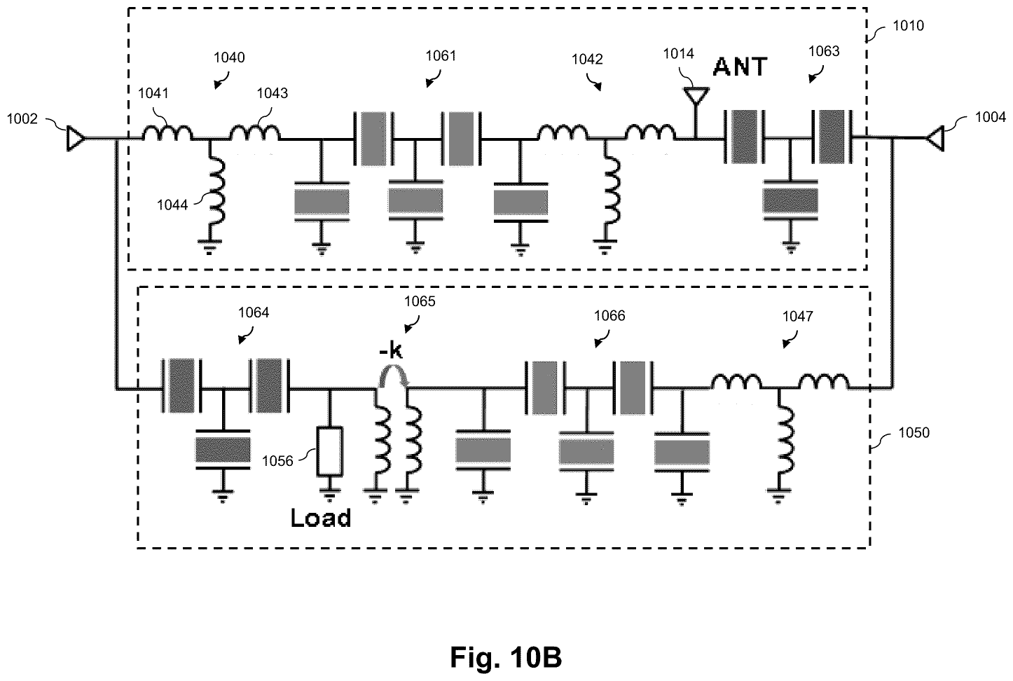

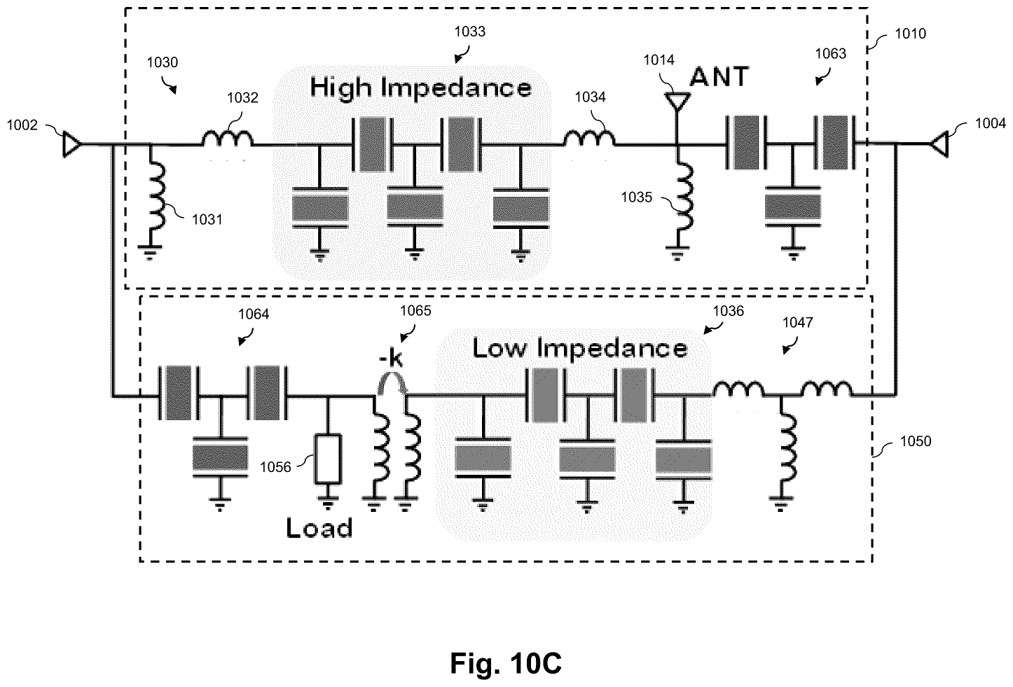

As shown in FIG. 6, the receive filter 660 may include a ladder section 668, a coupled resonator filter 664, and a ladder section 662. The ladder sections 668 and 662 may be any suitable type of ladder section and may alternatively be referred to as ladder filters or ladder networks. In that regard, the ladder sections 668 and 662 may include a cascade of passive electronic components such as inductors, capacitors, and acoustic resonators or combinations thereof. The components of the ladder sections 668 and 662 may be arranged in a ladder-like configuration, with each stage of the filter being connected in series to the next. The output of one stage is fed into the input of the next stage, and so on. In some aspects, the ladder sections 668 and 662 may be similar to any of the ladder sections 1061, 1066, 1033, and/or 1036 described with reference to FIGS. 10A-10C.

Ladder sections may be included within a receive filter, such as the receive filter 660, to additionally refine the pass band of the receive filter 660 as needed or provide customized roll off (e.g., a steeper or more gradual roll off of the receive filter 660) as needed.

In some aspects, the coupled resonator filter 664 may be substantially similar to the coupled resonator filters 200A, 360A, and/or 360B described with reference to FIGS. 2, 3A, 3B, 5A, and/or 5B described previously.

In some aspects, the receive filter 670 may be substantially similar to the receive filter 660. For example, the receive filter 670 may be configured to be electrically symmetrical to the receive filter 660 such that the signals received from the transmit port 302 at the receive port 304 through the main signal path 610 as well as the auxiliary signal path 650 are equal save a signal inversion from the auxiliary signal path 650 leading to destructive interference at the receive port 304.

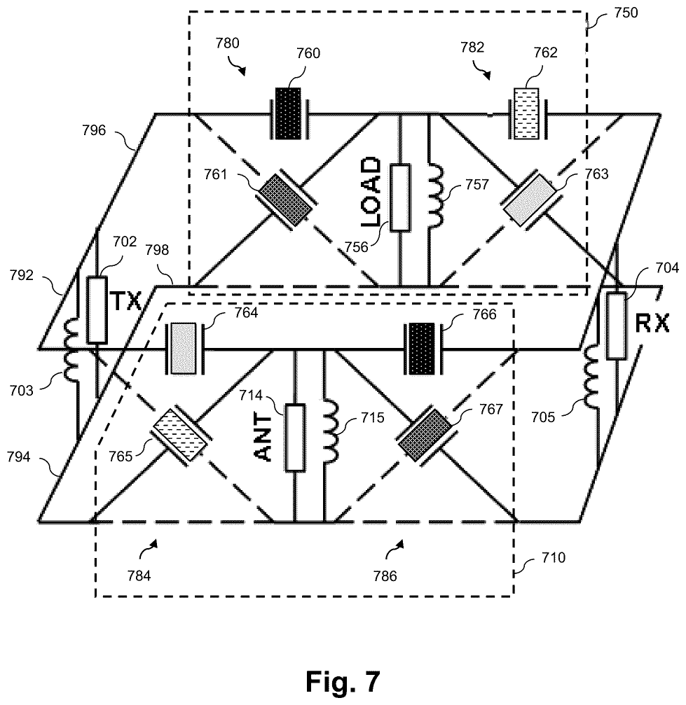

FIG. 7 is a schematic diagram of a dual inverted duplexer including lattice filters, according to aspects of the present disclosure. As shown, the dual inverted duplexer of FIG. 7 may include a transmit port 702, a receive port 704, an antenna 714, and a load 756.

Like the dual inverted duplexers previously described, the dual inverted duplexer of FIG. 7 includes a main signal path 710 and an auxiliary signal path 750. In particular, the main signal path 710 may include the signal path from the transmit port 702 to the receive port 704 including a piezoelectric resonator 764, a piezoelectric resonator 765, the antenna 714, a piezoelectric resonator 766, and a piezoelectric resonator 767. The auxiliary signal path 750 includes a piezoelectric resonator 760, a piezoelectric resonator 761, the load 756, a piezoelectric resonator 762, and a piezoelectric resonator 763. In that regard, like the dual inverted duplexers described previously, the auxiliary signal path 750 may be configured to be electrically identical to the main auxiliary path 710 save an arrangement to invert the signal of the auxiliary signal path 750.

As shown in FIG. 7, piezoelectric resonators of the dual inverted duplexer (e.g., piezoelectric resonators 760-767) may be arranged between the transmit port 702, antenna 714, load 756, and receive port 704 as lattice filters. In that regard, the piezoelectric resonators 760-767 may be arranged in a lattice structure. Each of the piezoelectric resonators 760-767 may be selected or configured according to a desired target frequency or frequency band. In some aspects, these target frequencies or frequency bands may correspond to lattice coefficients which may correspond to bandpass frequency response. The lattice filter configuration can be modified to support low-pass, high-pass, and band-stop responses by using other combinations of capacitors, inductors, and acoustic resonators in the lattice arms.

In that regard, as shown in FIG. 7, four conductors may connect the transmit port 702 to the receive port 704, with various electronical components positioned in series and/or in parallel as shown. In particular, a conductor 792 extends from one end of the transmit port 702 and extends along the main signal path 710 to a corresponding end of the receive port 704. A conductor 796 extends from the same end of the transmit port 702 and along the auxiliary signal path 750 to the same corresponding end of the receive port 704. A conductor 794 extends from the opposite end of the transmit node 702 and along the main signal path 710 to a corresponding opposite end of the receive node 704. A conductor 798 extends from the transmit port 702 along the auxiliary signal path 750 to the receive node 704. In some aspects, the circuit of the dual inverted duplexer shown in FIG. 7 may correspond to a balanced arrangement. In that regard, a signal sent from one end of the transmit port 702 may be a positive signal relative to a negative signal from the opposite of the transmit port 702. In some aspects, BALUN circuits can be used to convert various differential ports into balanced ports and various portions of the circuit may be tied to ground. In that regard, the circuit shown in FIG. 7 may alternatively be an unbalanced circuit.

Each piezoelectric resonator of the piezoelectric resonators 760-767 may be of a similar structure. For example, any of these piezoelectric resonators may include a piezoelectric material positioned between two electrodes mounted on a substrate. Each of the electrodes of the piezoelectric resonators may be coupled to leads extending from either side of the piezoelectric resonators as shown in FIG. 7. Each piezoelectric resonator may correspond to a resonant frequency determined by features of the piezoelectric resonator such as the thickness or shape of piezoelectric material or a DC bias voltage of the electrodes.

In the dual inverted duplexer shown in FIG. 7, the piezoelectric resonator 762 and the piezoelectric resonator 763 may form a transmit filter of the auxiliary signal path 750. The piezoelectric resonator 764 and the piezoelectric resonator 765 may form a transmit filter of the main signal path 710. In some aspects, the resonant frequency of the piezoelectric resonator 762 may be selected to be a similar but different frequency than the resonant frequency of the piezoelectric resonator 763.

The piezoelectric resonator 760 and the piezoelectric resonator 761 may form a receive filter of the auxiliary signal path 750. The piezoelectric resonator 766 and the piezoelectric resonator 767 may form a receive filter of the main signal path 710.

Referring again to FIG. 1, for cancellation of the signal of the main signal path 110 and the auxiliary signal path 150 to be achieved, the signal of the auxiliary signal path 150 is inverted (e.g., by the mechanism 154). In the example shown in FIG. 7, the auxiliary signal path 750 may invert the signal by switching piezoelectric resonators relative to the main signal path. In that regard, one of the filters of the auxiliary signal path 750 is of reverse polarity. In particular, the receive filter 780 formed by the piezoelectric resonators 760 and 761 may be electrically symmetrical with the receive filter 786 formed by the piezoelectric resonators 766 and 767. In that regard, the piezoelectric resonator 760 may be substantially similar to the piezoelectric resonator 766 in electrical and acoustic properties. In addition, as shown, the piezoelectric resonators 760 and 766 are both arranged along the conductors extending from the same end of the transmit port 702 (e.g., conductors 796 and 792 respectively). Similarly, the piezoelectric resonator 761 may be substantially similar to the piezoelectric resonator 767 in electrical and acoustic properties and arranged in the same way relative to the conductors. However, piezoelectric resonators 762 and 763 forming the transmit filter 782 of the auxiliary signal path 750 may be reversed relative to the piezoelectric resonators 764 and 765 forming the transmit filter 784 of the main signal path 710. In particular, the piezoelectric resonator 762 may be substantially similar to the piezoelectric resonator 765 in electrical and acoustic properties while the piezoelectric resonator 763 may be substantially similar to the piezoelectric resonator 764 in electrical and acoustic properties.

As shown, an inductor 703 may be positioned adjacent to the transmit port 702 extending from the conductor 792 to the conductor 794. An inductor 715 may be positioned adjacent to the antenna 714 extending from the conductor 792 to the conductor 794. An inductor 757 may be positioned adjacent to the load 756 extending from the conductor 796 to the conductor 798. An inductor 705 may be positioned adjacent to the receive port 704 extending from the conductor 792 to the conductor 794. In some aspects, any of the inductors 703, 715, 757, and/or 705 may be positioned on the other side of the transmit port 702, antenna 714, load 756, and/or receive port 704 respectively. In some aspects, any of the inductors 703, 704, 715, and/or 757 may serve as matching components for the operation of the lattice filters.

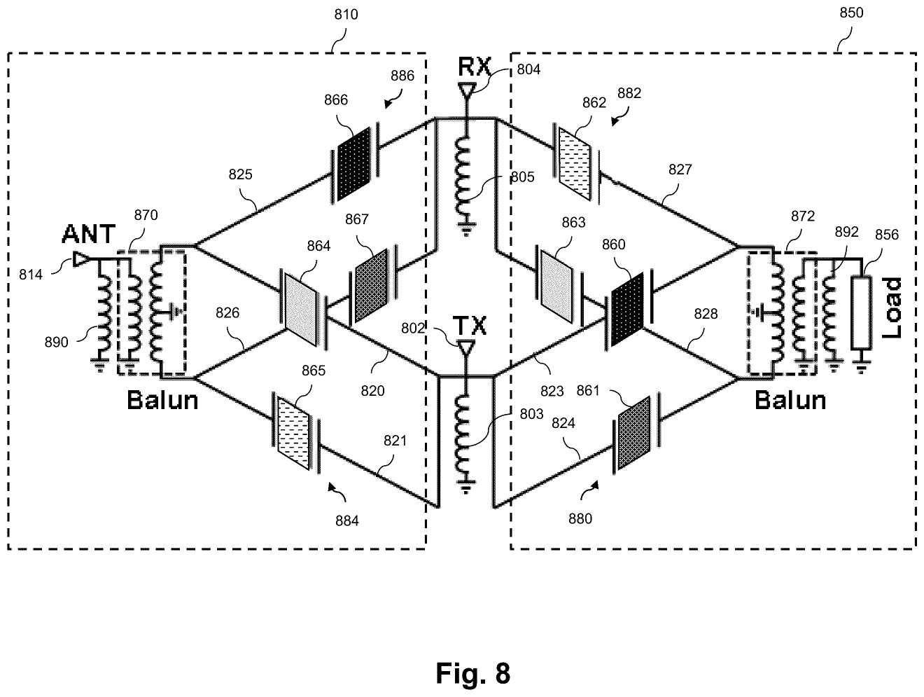

FIG. 8 is a schematic diagram of a dual inverted duplexer including hybrid lattice filters, according to aspects of the present disclosure. As shown, the dual inverted duplexer of FIG. 8 may include a transmit port 802, a receive port 804, an antenna 814, and a load 856.

Like the dual inverted duplexers previously described, the dual inverted duplexer of FIG. 8 includes a main signal path 810 and an auxiliary signal path 850. In particular, the main signal path 810 may include the signal path from the transmit port 802 to the receive port 804 including a piezoelectric resonator 864, a piezoelectric resonator 865, the antenna 814, a piezoelectric resonator 866, and a piezoelectric resonator 867. The auxiliary signal path 850 includes a piezoelectric resonator 860, a piezoelectric resonator 861, the load 856, a piezoelectric resonator 862, and a piezoelectric resonator 863. In that regard, like the dual inverted duplexers described previously, the auxiliary signal path 850 may be configured to be electrically identical to the main signal path 810 save an arrangement to invert the signal of the auxiliary signal path 850.

As shown in FIG. 8, piezoelectric resonators of the dual inverted duplexer (e.g., piezoelectric resonators 860-867) may be arranged between the transmit port 802, antenna 814, load 856, and receive port 804 as hybrid lattice filters. In that regard, the piezoelectric resonators 860-867 may be arranged in a hybrid lattice structure. Each of the piezoelectric resonators 860-867 may be selected or configured according to a desired target frequency or frequency band. In some aspects, these target frequencies or frequency bands may correspond to lattice coefficients which may be correspond to bandpass frequency response. The lattice filter configuration can be modified to support low-pass, high-pass, and band-stop responses by using other combinations of capacitors, inductors, and acoustic resonators in the lattice arms.

In that regard, as shown in FIG. 8, four conductors may connect the transmit port 802 to the receive port 804, with various electronical components positioned in series and/or in parallel as shown. In particular, conductors 820 and 821 split from one end of the transmit port 802 and extends along the main signal path 810 to the antenna 814. Conductors 825 and 826 extend from the antenna 814 and join before connecting to one end of the receive port 804. Conductors 823 and 824 split from the end of the transmit port 802 and along the auxiliary signal path 850 to the load 856. Conductors 827 and 828 extend from the load 856 and join before connection to the end of the receive port 804. In some aspects, the circuit of the dual inverted duplexer shown in FIG. 7 may correspond to an unbalanced arrangement.

Each piezoelectric resonator of the piezoelectric resonators 860-867 may be of a similar structure. For example, any of these piezoelectric resonators may be of a similar structure as the piezoelectric resonators 760-767 described with reference to FIG. 7.

In the dual inverted duplexer shown in FIG. 8, the piezoelectric resonator 862 and the piezoelectric resonator 863 may form a transmit filter 882 of the auxiliary signal path 850. The piezoelectric resonator 864 and the piezoelectric resonator 865 may form a transmit filter 884 of the main signal path 810. In some aspects, the resonant frequency of the piezoelectric resonator 862 may be selected to be a similar but different frequency than the resonant frequency of the piezoelectric resonator 863.

The piezoelectric resonator 860 and the piezoelectric resonator 861 may form a receive filter 880 of the auxiliary signal path 850. The piezoelectric resonator 866 and the piezoelectric resonator 867 may form a receive filter 886 of the main signal path 810.

Referring again to FIG. 1, for cancellation of the signal of the main signal path 110 and the auxiliary signal path 150 to be achieved, the signal of the auxiliary signal path 850 is inverted (e.g., by the mechanism 154). In the example shown in FIG. 8, the auxiliary signal path 850 may invert the signal by switching piezoelectric resonators relative to the main signal path 810. In that regard, one of the filters of the auxiliary signal path 850 is of reverse polarity. In particular, the receive filter 880 formed by the piezoelectric resonators 860 and 861 may be electrically identical with the receive filter 886 formed by the piezoelectric resonators 866 and 867. In that regard, the piezoelectric resonator 860 may be substantially similar to the piezoelectric resonator 866 in electrical and acoustic properties. In addition, as shown, the piezoelectric resonators 860 and 866 are both arranged along the same conductors relative to the load 856 and the antenna 814 respectively (e.g., conductors 823 and 825 respectively). Similarly, the piezoelectric resonator 861 may be substantially similar to the piezoelectric resonator 867 in electrical and acoustic properties and arranged in the same way relative to the conductors. However, piezoelectric resonators 862 and 863 forming the transmit filter 882 of the auxiliary signal path 850 may be reversed relative to the piezoelectric resonators 864 and 865 forming the transmit filter 884 of the main signal path 810. In particular, the piezoelectric resonator 862 may be substantially similar to the piezoelectric resonator 865 in electrical and acoustic properties while the piezoelectric resonator 863 may be substantially similar to the piezoelectric resonator 864 in electrical and acoustic properties.

As shown, an inductor 703 may be positioned between one end of the transmit port 802 to ground, as shown. Similarly, an inductor 805 may be positioned between one end of the receive port 804 to ground. An inductor 814 may be positioned between one end of the antenna 814 to ground and an inductor 892 may be positioned between one end of the load 856 to ground.

In addition, the conductors 820, 821, 825, and 826 may be connected to the antenna 814 via a balun 870. Similarly, the conductors 823, 824, 827, and 828 may be connected to the load 856 via a balun 872. In some aspects, the baluns 870 and 872 may be substantially similar to one another. In some aspects, each of the baluns 870 and 872 may convert the balanced signals received via the pairs of conductors (e.g., conductors 820 and 821, conductors 825 and 826, conductors 823 and 824, and conductors 827 and 828) to an unbalanced signal to be transmitted via the antenna or to pass to the load 856. The baluns 870 and 872 may include multiple transformer coils, as shown.

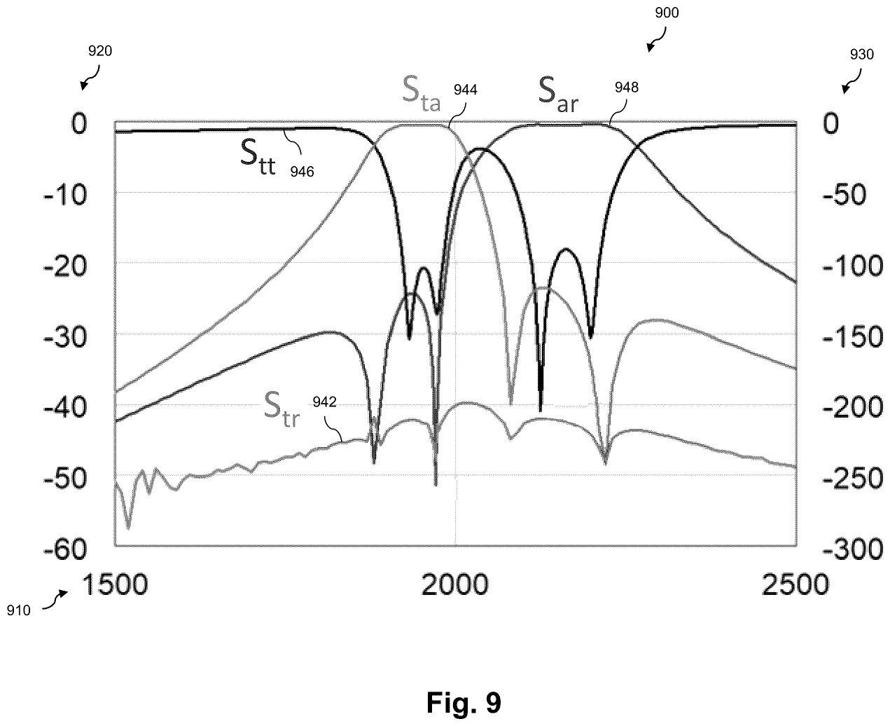

FIG. 9 is a graphical representation of the electrical performance of a dual inverted duplexer including hybrid lattice filters, according to aspects of the present disclosure. As shown, FIG. 9 includes a plot 900. In particular, the data shown in the plot 900 may illustrate the performance of the dual inverted duplexers described with reference to FIGS. 7-8. In that regard, the plot 900 includes an axis 910 corresponding to frequency, an axis 920 corresponding to insertion loss and return loss, and an axis 930 corresponding to TX-RX isolation.

Aspects of FIG. 9 may be substantially similar to FIG. 4 previously described. As shown in FIG. 9, the plot includes various data. The data may include a data set 944, a data set 948, a data set 946, and a data set 942. Each of these data sets may correspond to scattering parameters (S-parameters) of different ports of either of the dual inverted duplexers of FIGS. 7-8. These different ports may include, for example, the transmit port 702 or 802, the receive port 704 or 804, and the antenna 714 or 814. In that regard, the data sets 942-948 may correspond to the ratio of voltage wave amplitudes observed at each of these ports as power is fed into one of these ports. In some aspects, as shown by the axes 920 and 930, these measurements may be displayed in decibels (dB). In particular, as described with reference to FIG. 4, these measurements may be shown as a calculation of dB loss as a logarithmic operation of a squared absolute value of voltage ratio.

In some aspects, the data set 944 may represent power transmitted from the transmit port to the antenna (Sₜₐ). In that regard, it may be desirable to optimize power from the transmit port to the antenna within the passband of frequencies (i.e., ˜1900 MHz-2000 MHz in the example shown in FIG. 9, though this passband may be selected to be any suitable range as needed). In other words, within the passband, the dB loss from the transmit port to the antenna should be as low as possible, or as close to 0 dB as possible. As shown in FIG. 9, the dB loss of the data set 944 representing power from the transmit port to the antenna is very low (i.e., around 1 dB or less). In the plot 900 shown, the data set 944 may correspond to the left axis 920.

The data set 948 may represent power transmitted from the antenna to the receive port (Sₐᵣ). Within the passband of frequencies for the receive signal path (i.e., ˜2100 MHz-2250 MHz in the example shown in FIG. 9, though this passband may be selected to be any suitable range as needed), it may be desirable to optimize power from the antenna to the receive port, or that the loss within this passband be as low as possible, or as close to 0 dB as possible. As shown in FIG. 9, the dB loss of the data set 948 representing power from the antenna to the receive port is very low (i.e., around 1 dB or less). In the plot 900 shown, the data set 948 may correspond to the left axis 920.

The data set 946 may correspond to power reflected back to the transmit port (Sₜₜ). In particular, when power is fed through the transmit port into the dual inverted duplexer circuit (e.g., through the transmit port 702 or 802), some amount of power is reflected back through the transmit port. This amount of power may be illustrated by the data set 946. In some aspects, it may be desirable for the amount of reflected power to be less than 15 dB within the transmit and/or receive passbands. As shown, within these passbands, the reflected dB loss is largely at or below 20 dB. In the plot 900 shown, the data set 946 may correspond to the left axis 920. It is noted, that due to the symmetry of the dual inverted duplexer circuits described herein, the data set 946 may equally represent power reflected at any of the ports of the circuit, including at the receive port or the antenna.

The data set 942 may correspond to power leakage from the transmit port to the receive power, or Tx-Rx leakage (Sₜᵣ). In the plot 900 shown, the data set 942 may correspond to the right axis 930. As shown in the plot 900, the amount of power which leaks from the transmit port to the receive port is extremely low due to the cancellation effect between the main signal path and auxiliary signal path. In the example shown, the data set 942 shows a dB loss of around 200 dB (i.e., ˜200-300 dB frequency dependent loss) which corresponds to essentially perfect isolation of the receive port from the transmit port.

FIG. 10A is a schematic diagram of a ladder-based dual inverted duplexer, according to aspects of the present disclosure. As shown, the dual inverted duplexer of FIG. 10A may include a transmit port 1002, a receive port 1004, an antenna 1014, and a load 1056.

Like the dual inverted duplexers previously described, the dual inverted duplexer of FIG. 10A includes a main signal path 1010 and an auxiliary signal path 1050. In particular, the main signal path 1010 may include the signal path from the transmit port 1002 to the receive port 1004 including a transformer 1060, a ladder filter 1061, a transformer 1062, the antenna 1014, and a ladder filter 1063. In some aspects, the transformer 1060, ladder filter 1061, and transformer 1062 may form a transmit filter. In some aspects, the ladder filter 1063 may form a receive filter. The auxiliary signal path 1050 may include a ladder filter 1064, the load 1056, a transformer 1065, a ladder filter 1066, and a transformer 1067. In some aspects, the transformer 1065, ladder filter 1066, and transformer 1067 may form a transmit filter and the ladder filter 1064 may form a receive filter. Like the dual inverted duplexers described previously, the auxiliary signal path 1050 may be configured to be electrically identical to the main auxiliary path 1010 save an arrangement to invert the signal of the auxiliary signal path 1050. In some aspects, any of the transformers described herein may be mutually coupled inductors.

As shown in FIG. 10A, the ladder filter 1061 may include multiple piezoelectric resonators arranged in series and in parallel. In particular, the ladder filter 1061 may include a piezoelectric resonator 1080 arranged in parallel to ground, a piezoelectric resonator 1081 in series, a piezoelectric resonator 1082 in parallel to ground, a piezoelectric resonator 1083 in series, and a piezoelectric resonator 1084 in parallel to ground. In some aspects, each of the piezoelectric resonators 1080-1084 may be substantially similar to one another. For example, each piezoelectric resonator of the piezoelectric resonators 1080-1084 may have the same resonant frequency and have the same electric and acoustic properties.

In some aspects, the ladder filter 1066 may be substantially similar to the ladder filter 1061. In particular, the ladder filter 1066 may include the same number, type, and arrangement of piezoelectric resonators including piezoelectric resonators of the same resonant frequency and electric and acoustic properties as the piezoelectric resonators 1080-1084.

The ladder filter 1063 may also include multiple piezoelectric resonators arranged in series and in parallel. In particular, the ladder filter 1063 may include a piezoelectric resonator 1090 arranged in series, a piezoelectric resonator 1091 arranged in parallel to ground, and a piezoelectric resonator 1092 in series. In some aspects, each of the piezoelectric resonators 1090-1092 may be substantially similar to one another. For example, each piezoelectric resonator of the piezoelectric resonators 1090-1092 may have the same resonant frequency and have the same electric and acoustic properties.

In some aspects, the ladder filter 1064 may be substantially similar to the ladder filter 1063. In particular, the ladder filter 1064 may include the same number, type, and arrangement of piezoelectric resonators including piezoelectric resonators of the same resonant frequency and electric and acoustic properties as the piezoelectric resonators 1090-1092.

Each piezoelectric resonators shown in FIG. 10A may be of a similar structure. For example, any of these piezoelectric resonators may be of a similar structure as the piezoelectric resonators 760-767 described with reference to FIG. 7.

Referring again to FIG. 1, for cancellation of the signal of the main signal path 110 and the auxiliary signal path 150 to be achieved, the signal of the auxiliary signal path is inverted (e.g., by the mechanism 154). In the example shown in FIG. 10A, the auxiliary signal path 1050 may invert the signal by switching the polarity of the transformer 1065. In that regard, the transformer 1065 is of reverse polarization with reference to the other transformers of the circuit. In particular, each of the transformers 1060, 1062, and 1067 may be wired in a similar way, leading to the same polarity. This is shown in FIG. 10A by the “k” indications above each of the transformers 1060, 1062, and 1067. However, one of the inductors of the transformer 1065 may be reverse wound, resulting in an opposite polarity of the transformer 1065 (as shown by the “−k” indication) causing the signal through the auxiliary signal path 1050 to be inverted leading to destructive interference at the receive port 1004.

FIG. 10B is a schematic diagram of a ladder-based dual inverted duplexer, according to aspects of the present disclosure. In some aspects, the dual inverted duplexer of FIG. 10B may be substantially similar to the dual inverted duplexer of FIG. 10A. As shown, the dual inverted duplexer of FIG. 10B includes the transmit port 1002, the receive port 1004, the antenna 1014, the load 1056, the ladder filter 1061, the ladder filter 1063, the ladder filter 1064, the ladder filter 1066, and the transformer 1065 of inverted polarity. However, in the dual inverted duplexer of FIG. 10B, the transformers 1060, 1062, and 1067 (see FIG. 10A) have been replaced with T-equivalents.

In particular, the transformer 1060 has been replaced with the T-equivalent circuit 1040. The T-equivalent circuit 1040 includes an inductor 1041 in series, an inductor 1044 in parallel to ground, and an inductor 1043 in series. In some aspects, the inductors 1041, 1044, and 1043 may be selected so as to replicate the performance of a transformer. Similarly, the transformer 1062 has been replaced with the T-equivalent circuit 1042. The transformer 1067 has been replaced with the T-equivalent circuit 1047.

FIG. 10C is a schematic diagram of a ladder-based dual inverted duplexer, according to aspects of the present disclosure. In some aspects, the example of the ladder-based dual inverted duplexer of FIG. 10C may be similar to the dual inverted duplexers shown and described with reference to FIGS. 10A and 10B.

In particular, referring again to FIG. 10A, The transformer 1060 and transformer 1062 may be components of lesser impedance than the ladder filter 1061. Similarly, the transformers 1065 and 1067 may be of lesser impedance than the ladder filter 1066. As shown in FIG. 10C, a ladder filter 1033 may be included along the main signal path 1010 and a ladder filter 1036 may be included along the auxiliary signal path 1050. In some aspects, the characteristics of the ladder filter 1036 may be substantially similar to the characteristics of the ladder filter 1066 shown and described with reference to FIGS. 10A and 10B. However, the impedances of the piezoelectric resonators of the ladder filter 1033 may be selected such that the transformers 1060 and 1062 are absorbed into the ladder filter 1033 or the transformers 1060 and 1062 are not needed. Instead, on either side of the ladder filter 1033 are inductors 1031, 1032, 1034, and 1035, with the inductor 1031 arranged in parallel to ground, the inductor 1032 arranged in series, the inductor 1034 arranged in series, and the inductor 1035 arranged in parallel to ground. In some aspects, the implementation of the ladder filter 1033 and inductors 1031, 1032, 1034, and 1035 may be simpler or more cost-effective implementation of the dual inverted duplexer. However, as shown in FIG. 10C, the ladder filter 1033 may be of a higher impedance than the ladder filter 1036. In some aspects, this difference in impedance may lead to differences in loss along the main signal path 1010 and auxiliary signal path 1050 which may lead to different amplitudes of the signal received from these paths respectively at the receive port 1004. In that regard, isolation of the transmit port 1002 and receive port 1004 may be degraded. However, each particular application of the dual inverted duplexer may dictate the balance of cost and performance to determine which implementation of the dual inverted duplexer is to be used.

It is noted that any of the dual inverted duplexer circuits described herein may include any suitable shielding of conductors. For example, shield may be applied between windings of any of the transformers described herein. In that regard, aspects of shielding any conductors of the circuits described herein may include any principles described in U.S. Pat. No. 11,764,747B2, titled “TRANSFORMER BALUN FOR HIGH REJECTION UNBALANCED-UNBALANCED LATTICE FILTERS” which is hereby incorporated by reference in its entirety.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

1. A duplexer system, comprising:
a first signal path from a transmit port to a receive port, the first signal path comprising:
a first transmit filter;
an antenna; and
a first receive filter; and
a second signal path from the transmit port to the receive port, the second signal path comprising:
a second receive filter;
a load; and
a second transmit filter,
wherein the first signal path and the second signal path are configured such that a first signal received at the receive port from the first signal path is inverted relative to a second signal received at the receive port from the second signal path.

2. The duplexer system of claim 1, wherein an impedance of the load of the second signal path matches an impedance of the antenna of the first signal path.

3. The duplexer system of claim 1, wherein the first transmit filter and the second transmit filter are electrically symmetrical.

4. The duplexer system of claim 1, wherein the first receive filter and the second transmit filter are electrically symmetrical.

5. The duplexer system of claim 1, wherein either the first receive filter and the second receive filter or the first transmit filter and the second transmit filter form a set of coupled resonator filters.

6. The duplexer system of claim 5, wherein one coupled resonator filter the set of coupled resonator filters includes a reverse polarization piezoelectric resonator.

7. The duplexer system of claim 5, wherein one coupled resonator filter of the set of coupled resonator filters is arranged with connection leads that are reversed relative to the other coupled resonator filter of the set of coupled resonator filters.

8. The duplexer system of claim 7, wherein the second signal path further includes a capacitance to ground component corresponding to a difference in capacitance between the coupled resonator filters of the set of coupled resonator filters.

9. The duplexer system of claim 1, wherein each of the first transmit filter, the first receive filter, the second receive filter, and the second transmit filter are coupled resonator filters.

10. The duplexer system of claim 1, wherein either the first receive filter and the second receive filter or the first transmit filter and second transmit filter form a set of stacked crystal filters.

11. The duplexer system of claim 10, wherein one of the stacked crystal filters of the set of stacked crystal filters includes a reverse polarization piezoelectric resonator.

12. The duplexer system of claim 1, wherein either the first receive filter and the second receive filter or the first transmit filter and second transmit filter form a set of hybrid filters, each hybrid filter of the set of hybrid filters including a coupled resonator filter and one or more ladder filter sections. 13 The duplexer system of claim 1, wherein either the first transmit filter and the second transmit filter or the first receive filter and the second receive filter form a set of lattice filters.

14. The duplexer system of claim 13, wherein one lattice filter of the set of lattice filters includes a pair of reversed piezoelectric resonators relative to the other lattice filter of the set of lattice filters.

15. The duplexer system of claim 1, wherein either the first transmit filter and second transmit filter or the first receive filter and second receive filter form a set of hybrid lattice filters, and wherein one hybrid lattice filter of the set of hybrid lattice filters includes a pair of reversed piezoelectric resonators relative to the other hybrid lattice filter of the set of hybrid lattice filters.

16. The duplexer system of claim 1, wherein the first signal path further comprises a first pair of mutually coupled inductors and the second signal path further comprises a second pair of mutually coupled inductors of opposite polarization than the first pair of mutually coupled inductors.

17. The duplexer system of claim 1, wherein the second signal path further comprises a pair of mutually coupled inductors with negative mutual coupling and wherein the first signal path includes a plurality of inductors arranged in a T network.

18. The duplexer system of claim 1, wherein the second receive filter is in electrical communication with the transmit port and an input of the first transmit filter and an input of the second transmit filter is in electrical communication with the receive port and an output of the first receive filter.

19. A duplexer system, comprising:
a first signal path from a transmit port to a receive port, the first signal path comprising an antenna configured to transmit a first signal from the transmit port; and
a second signal path from the transmit port to the receive port, the second signal path comprising a component configured to generate a second signal by inverting the first signal such that the first signal and the second signal destructively interfere.

20. A method of improving isolation of a receive port from a transmit port in a duplexer, comprising:
transmitting a signal from the transmit port along a first signal path and a second path, the first signal path comprising:
a first transmit filter;
an antenna; and
a first receive filter;
the second signal path comprising:
a second receive filter;
a load; and
a second transmit filter, and
receiving the signal at the receive port wherein an amplitude of the signal received is decreased by destructive interference.
